(19) United States
(12) Patent Application Publication
(10) Pub. No.: US 2025/0148466 A1
(43) Pub. Date: May 8, 2025

(54) TERMINAL, SYSTEM, CONTROL METHOD OF TERMINAL AND STORAGE MEDIUM

(71) Applicant: NEC Corporation, Minato-ku, Tokyo (JP)

(72) Inventors: Eri KOKAJI, Tokyo (JP); Kazufumi Hoshi, Tokyo (JP)

(73) Assignee: NEC Corporation, Minato-ku, Tokyo (JP)

(21) Appl. No.: 18/838,699

(22) PCT Filed: Mar. 11, 2022
(86) PCT No.: PCT/JP2022/010770

§ 371 Date: Aug. 15, 2024

(51) Int. Cl. G06Q 20/40

(52) U.S. Cl. CPC G06Q 20/40145

(57) ABSTRACT

A terminal includes an identity verification unit and a ticket issuance control unit. The identity verification unit performs an identity verification of a ticket purchase applicant by a first biometric authentication using a first biometric information acquired from an identity verification document and a second biometric information of the ticket purchase applicant. The identity verification unit stores a third biometric information of the ticket purchase applicant who has been successfully verified. The ticket issuance control unit performs a second biometric authentication using a fourth biometric information of a ticket issuance applicant and the stored third biometric information. The ticket issuance control unit performs a processing related to an issuance of a ticket when the second biometric authentication has been successful.

### TECHNICAL FIELD

The present invention relates to a terminal, a system, a control method of a terminal, and a storage medium.

### BACKGROUND ART

There are technologies for authenticating ticket purchasers and for managing entry to facilities.

For example, Patent Literature 1 describes a system that improves convenience for customers who use a ticket. An authentication system in Patent Literature 1 includes a customer terminal, an authentication apparatus, and an information processing apparatus. The information processing apparatus includes a control unit and a storage unit. The storage unit stores personal information and biometric information received from the customer terminal. The control unit receives biometric information and event information along with a ticket purchase request from the customer terminal. When the control unit compares the biometric information stored in the storage unit with the biometric information received along with the ticket purchase request and permits biometric authentication, the control unit transmits a ticket purchase permission notification corresponding to the ticket purchase request to the customer terminal. When the control unit receives a first authentication request or a second authentication request from the authentication apparatus, compares the biometric information stored in the storage unit with the biometric information included in the first authentication request or the second authentication request, and permits biometric authentication, the control unit transmits an authentication permission notification to the authentication apparatus.

### CITATION LIST

### Patent Literature

[PTL 1] Japanese Unexamined Patent Application Publication No. JP2019-057004

### SUMMARY OF INVENTION

### Technical Problem

As disclosed in Patent Literature 1, biometric authentication is sometimes used for entry to an event venue, or the like. Here, as disclosed in Patent Literature 1, biometric information used to authenticate a person to be authenticated is often stored by a server. In this case, an authentication apparatus installed at an entrance or the like to the event venue transmits the biometric information of the person to be authenticated to the server, and the server determines whether or not the person to be authenticated can enter the event venue using biometric authentication.

In this way, a client-server biometric authentication system as described above needs a server that stores biometric information and an authentication apparatus that acquires biometric information of a person to be authenticated. However, it is a heavy burden for an event organizer to prepare the above dedicated apparatuses (server and authentication apparatus) for a one-off event such as an outdoor music concert.

According to the individual aspects of the present invention, there is provided a terminal, a system, a control method of a terminal, and a storage medium, which contribute to more easily realize an entry control of a user to an event venue or the like using biometric authentication.

### Solution to Problem

According to a first aspect of the present invention, there is provided a terminal including: an identity verification unit that performs an identity verification of a ticket purchase applicant by a first biometric authentication using a first biometric information acquired from an identity verification document and a second biometric information of the ticket purchase applicant, and stores a third biometric information of the ticket purchase applicant who has been successfully verified; and a ticket issuance control unit that performs a second biometric authentication using a fourth biometric information of a ticket issuance applicant and the stored third biometric information, and performs a processing related to an issuance of a ticket when the second biometric authentication has been successful.

According to a second aspect of the present invention, there is provided a system including: a server apparatus that sells tickets; and a terminal, wherein the terminal includes: an identity verification unit that performs an identity verification of a ticket purchase applicant by a first biometric authentication using a first biometric information acquired from an identity verification document and a second biometric information of the ticket purchase applicant, and stores a third biometric information of the ticket purchase applicant who has been successfully verified; a ticket purchase control unit that accesses the server apparatus after the identity verification has been successful, receives a ticket ID of a ticket purchased from the server apparatus, and stores the received ticket ID; and a ticket issuance control unit that performs a second biometric authentication using a fourth biometric information of a ticket issuance applicant and the stored third biometric information, and performs a processing related to an issuance of a ticket when the second biometric authentication has been successful.

According to a third aspect of the present invention, there is provided a control method of a terminal, the control method including: performing an identity verification of a ticket purchase applicant by a first biometric authentication using a first biometric information acquired from an identity verification document and a second biometric information of the ticket purchase applicant, and storing a third biometric information of the ticket purchase applicant who has been successfully verified; and performing a second biometric authentication using a fourth biometric information of a ticket issuance applicant and the stored third biometric information, and performing a processing related to an issuance of a ticket when the second biometric authentication has been successful.

According to a fourth aspect of the present invention, there is provided a computer-readable storage medium storing a program causing a computer mounted on a terminal to perform processing for: performing an identity verification of a ticket purchase applicant by a first biometric authentication using a first biometric information acquired from an identity verification document and a second biometric information of the ticket purchase applicant, and storing a third biometric information of the ticket purchase applicant who has been successfully verified; and performing a second biometric authentication using a fourth biometric information of a ticket issuance applicant and the stored third biometric information, and performing a processing related to an issuance of a ticket when the second biometric authentication has been successful.

### Advantageous Effects of Invention

According to the individual aspects of the present invention, there is provided a terminal, a system, a control method of a terminal, and a storage medium, which contribute to more easily realize an entry control of a user to an event venue or the like using biometric authentication. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an operation of an example embodiment.

FIG. 3 is a diagram illustrating an example of a schematic configuration of an information processing system according to a first example embodiment.

FIG. 4 is a diagram illustrating an example of a display of a terminal according to the first example embodiment.

FIG. 5 is a diagram illustrating an example of a display of the terminal according to the first example embodiment.

FIG. 6 is a diagram illustrating an example of a display of the terminal according to the first example embodiment.

FIG. 7 is a diagram illustrating an operation of the information processing system according to the first example embodiment.

FIG. 8 is a diagram illustrating an example of a display of the terminal according to the first example embodiment.

FIG. 9 is a diagram illustrating an example of a display of the terminal according to the first example embodiment.

FIG. 10 is a diagram illustrating an operation of the information processing system according to the first example embodiment.

FIG. 11 is a diagram illustrating an operation of the information processing system according to the first example embodiment.

FIG. 12 is a diagram illustrating an operation of the information processing system according to the first example embodiment.

FIG. 13 is a diagram illustrating an example of a processing configuration of a server apparatus according to the first example embodiment.

FIG. 14 is a diagram illustrating an example of a display of the terminal according to the first example embodiment.

FIG. 15 is a diagram illustrating an example of a display of the terminal according to the first example embodiment.

FIG. 16 is a diagram illustrating an example of a sold ticket management database according to the first example embodiment.

FIG. 17 is a diagram illustrating an example of a processing configuration of an authentication terminal according to the first example embodiment.

FIG. 18 is a flowchart illustrating an example of an operation of a passage control unit according to the first example embodiment.

FIG. 19 is a diagram illustrating an example of a processing configuration of the terminal according to the first example embodiment.

FIG. 20 is a diagram illustrating an example of a purchased ticket management database according to the first example embodiment.

FIG. 21 is a diagram illustrating an example of a display of the terminal according to the first example embodiment.

FIG. 22 is a sequence diagram illustrating an example of an operation in the information processing system according to the first example embodiment.

FIG. 23 is a diagram illustrating an example of a hardware configuration of the server apparatus of the present application.

FIG. 24 is a diagram illustrating an operation of the information processing system for a variation of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

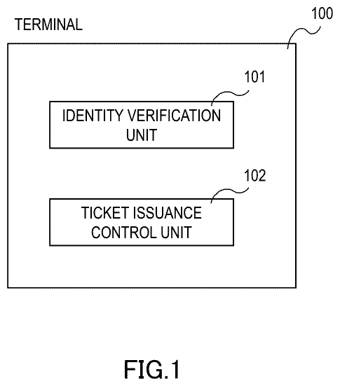

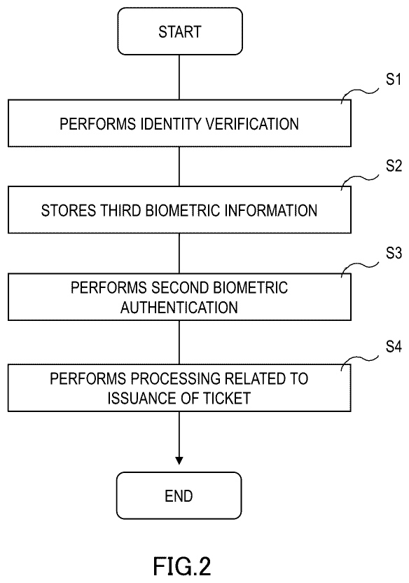

The terminal 100 according to an example embodiment includes an identity verification unit 101 and a ticket issuance control unit 102 (see FIG. 1). The identity verification unit 101 performs an identity verification of a ticket purchase applicant by a first biometric authentication using a first biometric information acquired from an identity verification document and a second biometric information of the ticket purchase applicant (step S1 in FIG. 2). The identity verification unit 101 stores a third biometric information of the ticket purchase applicant who has been successfully verified (step S2). The ticket issuance control unit 102 performs a second biometric authentication using a fourth biometric information of a ticket issuance applicant and the stored third biometric information (step S3). The ticket issuance control unit 102 performs a processing related to an issuance of a ticket when the second biometric authentication has been successful (performs a ticket issuance processing; step S4).

The terminal 100 performs identity verification using an identity verification document of a user before the user purchases a ticket. The terminal 100 performs the identity verification of a ticket purchase applicant by biometric authentication using a face photograph attached to the identity verification document and a face image acquired by capturing an image of the user (the ticket purchase applicant). In addition, when the user (a ticket issuance applicant) issues a purchased ticket, the terminal 100 determines whether a ticket purchaser and the ticket issuance applicant are the same person or not by biometric authentication using a face image acquired by photographing the user and the face image of the prior identity verification. The terminal 100 performs a processing related to issue a ticket when the ticket purchaser and the ticket issuance applicant are the same person. In this way, regarding authentication of a user, the terminal 100 can complete the authentication of the user through an internal processing of its own apparatus. That is, the terminal 100 can perform identity verification of the user who purchases a ticket and check the identity of the ticket purchaser and the ticket issuance applicant (person who enters an event venue) without using a server apparatus. Since the terminal 100 can properly authenticate the user without using the server apparatus, controlling the entry of users to the event venue, or the like, is more easily realized. That is, the event venue need only have a terminal that checks the validity of the ticket issued to the user, and there is no need to install a dedicated terminal for face recognition at the event venue.

Hereinafter, specific example embodiments will be described in more detail with reference to drawings.

### First Example Embodiment

A first example embodiment will be described in more detail with reference to drawings.

### System Configuration

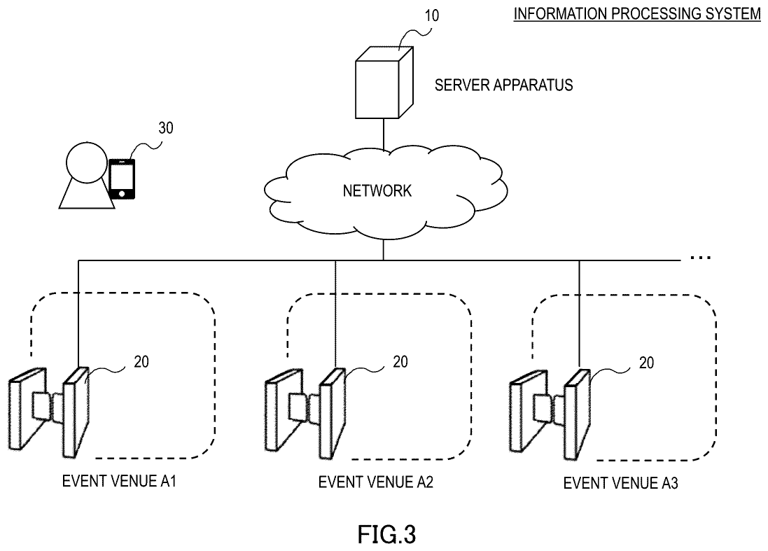

FIG. 3 is a diagram illustrating an example of a schematic configuration of an information processing system (authentication system, electronic ticket system) according to a first example embodiment. As shown in FIG. 3, the information processing system includes a server apparatus 10 and an authentication terminal 20.

The server apparatus 10 is managed and operated by a business operator, and so on that sells a ticket. An example of the ticket that the business operator sells is a ticket for an event such as a sport, concert, play, movie, and so on. Alternatively, the ticket that the above business operator sells may be a ticket for entry to an amusement park, and so on, or a ticket for an attraction, and so on installed at the amusement park.

The server apparatus 10 is an apparatus that handles ticket sales and the like. The server apparatus 10 may be installed in a building of the ticket sales operator that sells a ticket, or the server apparatus 10 may be installed on a network (on a cloud).

The authentication terminal 20 is, for example, an apparatus (a gate apparatus equipped with a gate) installed at an entrance to a restricted admission area where a user who do not possess a valid ticket is not permitted to enter. The authentication terminal 20 permits the user who possesses the valid ticket to pass through (enter the above-mentioned restricted admission area) and rejects the user who does not possess the valid ticket to pass through.

The user operates a terminal 30 in his or her possession and purchases the ticket.

The apparatuses illustrated in FIG. 3 are connected to each other. Specifically, the server apparatus 10 and the authentication terminals 20 are connected by wired or wireless communication means and are configured to be able to communicate with each other.

The configuration of the information processing system shown in FIG. 3 is an example and is not intended to limit the configuration of the authentication system. For example, the information processing system may include a plurality of the server apparatuses 10. Further, the information processing system may include at least one or more authentication terminals 20. Note that in the drawings, including FIG. 3, the authentication terminal 20 is illustrated as a gate apparatus equipped with the gate, but the authentication terminal 20 does not have to be equipped with the gate. The authentication terminal 20 need only be able to appropriately control an entry of an unauthorized person who attempts to enter the restricted admission area.

### Outline of Operation

Next, a schematic operation of the information processing system according to the first example embodiment will be described.

### <Installation of an Application>

At first, a user installs a “ticket management application” on the terminal 30. The user acquires the ticket management application by any means and installs the ticket management application on the terminal 30. For example, the user operates the terminal 30 to access the server apparatus 10 or a WEB (web) server that provides various applications, and acquires the ticket management application.

### <Initial Registration>

At first, a user starts the ticket management application and performs an initial registration (biometric information registration) required to purchase a ticket. Specifically, the user registers his or her own biometric information in the ticket management application.

Note that examples of the biometric information include data (feature values) calculated from physical features unique to an individual, such as a face, a fingerprint, a voiceprint, a vein, a retina, or an iris pattern of an eye. Alternatively, the biometric information may be image data such as a face image, a fingerprint image, and so on.

The biometric information may be anything that includes physical characteristics of a user as information. In the embodiment disclosed in the present application, a case in which biometric information related to a “face” of a person (a face image or a feature value generated from the face image) is used will be described.

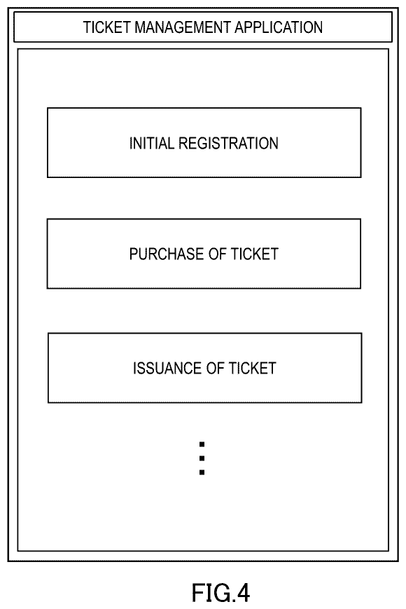

When the ticket management application is launched, a menu screen as shown in FIG. 4 is displayed on the terminal 30. When the user first uses the ticket management application, the user presses an “Initial Registration” button. In response to pressing the button, the terminal 30 displays a GUI (Graphical User Interface) to acquire an identity verification document and biometric information of the user.

Note that an example of the identity verification document to be acquired by the terminal 30 is a document with a photograph, such as a driver's license or a passport (a document issued by a public institution).

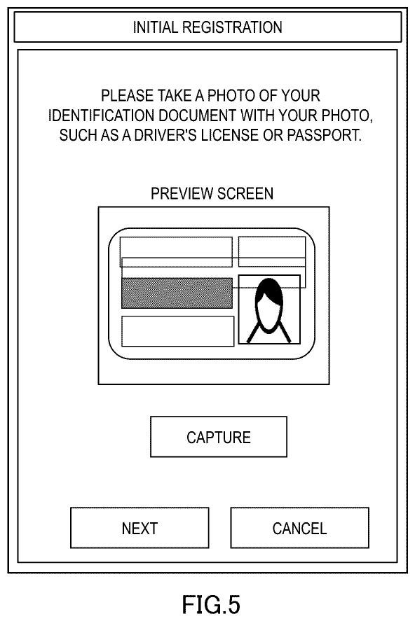

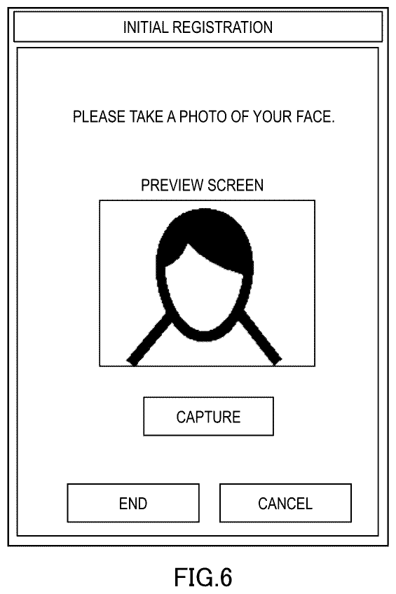

For example, the terminal 30 acquires an image acquired by capturing an image of an identity verification document (personal identification document) using a GUI such as that shown in FIG. 5. Moreover, the terminal 30 acquires a face image of the user using a GUI such as that shown in FIG. 6.

When the terminal 30 (the ticket management application) acquires the identity verification document and the face image, he terminal 30 performs identity verification using the identity verification document and the face image. Specifically, the terminal 30 performs an authentication processing (one-to-one authentication) using the acquired face image and the face image attached to the identity verification document, and when the authentication is successful, the terminal 30 determines that identity verification is successful.

When the identity verification is successful, the terminal 30 stores the fact that the identity verification has been successful. In addition, the terminal 30 stores the biometric information (biometric information acquired by capturing the image of the user or biometric information obtained from the identity verification document) of the user who has successfully completed identity verification.

### <Purchase of Ticket>

Once the initial registration is completed (when the identity verification is successful), the user is ready to purchase a ticket from the server apparatus 10. Specifically, once the initial registration is completed, the terminal 30 enables the “Purchase Ticket” button shown in FIG. 4 to be selectable.

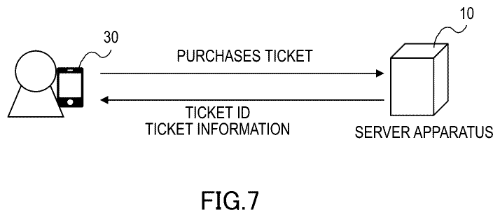

When the user presses the “Purchase Ticket” button shown in FIG. 4, the terminal 30 accesses the server apparatus 10 (see FIG. 7). For example, the user operates the terminal 30 to access a ticket sales site provided by the server apparatus 10.

The user operates the terminal 30 and purchases the ticket that the user intends to purchase. Moreover, the user registers information for identifying the terminal 30 from which the ticket was purchased (hereinafter referred to as “terminal identifying information”) with the server apparatus 10. Examples of the terminal identifying information include a terminal ID of the terminal 30 or an e-mail address that can be received by the terminal 30. Alternatively, a membership ID issued to the user, or the like may be used as the terminal identifying information.

When the server apparatus 10 sells a ticket to the user, the server apparatus 10 generates a ticket ID to identify the sold ticket.

The server apparatus 10 stores the ticket ID, the terminal identifying information, and information related to the sold ticket (hereinafter referred to as “ticket information”) in association with each other in a sold ticket management database. The ticket information includes an event name, event venue, and event date and time. Details of the sold ticket management database will be described below.

Further, the server apparatus 10 transmits the ticket ID and the ticket information to the terminal 30.

The terminal 30 (the ticket management application) stores the acquired ticket ID and ticket information in the purchase ticket management database. Details of the purchase ticket management database will be described below.

### <Use of Ticket>

The user who has purchased a ticket passes through the authentication terminal 20 and enters the restricted admission area. When the user arrives at an event venue, the user operates the terminal 30 to issue the ticket.

The user starts the ticket management application and presses an “Issue Ticket” button on a menu screen shown in FIG. 4. In response to pressing the button, the terminal 30 acquires biometric information of the user (the user who intends to issue the ticket).

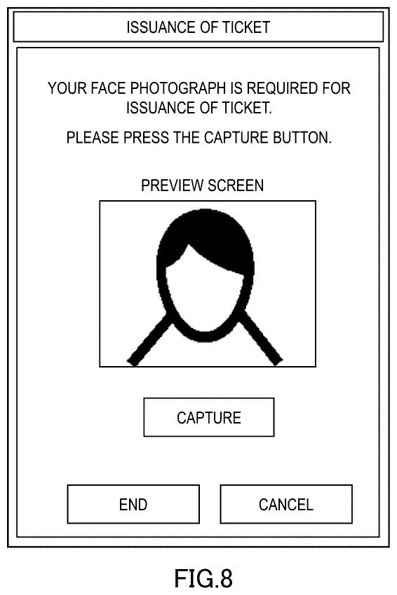

Specifically, the terminal 30 acquires the biometric information (face image) of the user using a GUI as shown in FIG. 8. After the terminal 30 acquires the face image, the terminal 30 performs biometric authentication (one-to-one authentication) using the biometric information stored at the time of identity verification and the biometric information acquired by capturing an image of the user.

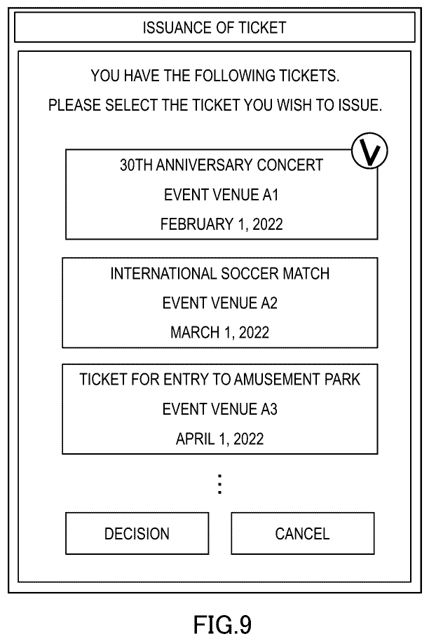

When the biometric authentication is successful, the terminal 30 displays a GUI that allows the user to select the ticket to be issued. For example, the terminal 30 displays a GUI as shown in FIG. 9. When the biometric authentication fails, the terminal 30 notifies the user that the ticket cannot be issued.

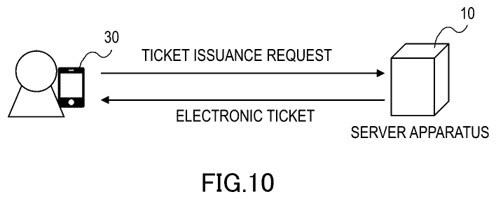

When the user selects the ticket to be issued in accordance with the GUI as shown in FIG. 9, the terminal 30 transmits a ticket issuance request that includes the ticket ID of the ticket and the terminal identifying information (for example, an e-mail address) to the server apparatus 10 (see FIG. 10).

The server apparatus 10 searches the sold ticket management database using the ticket ID included in the ticket issuance request as a key and identifies the corresponding entry. The server apparatus 10 compares the terminal identifying information of the identified entry with the terminal identifying information included in the ticket issuance request.

When the two pieces of terminal identifying information do not match, the server apparatus 10 determines that the ticket issuance request is from a terminal other than the terminal 30 where the ticket was purchased, and refuses to issue the ticket.

When the two pieces of terminal identifying information match, the server apparatus 10 issues the corresponding ticket. Specifically, the server apparatus 10 issues an electronic ticket in which the ticket ID and ticket information (for example, event name, event venue, event date and time, and so on) of the ticket to be issued are converted into a two-dimensional barcode.

At that time, the server apparatus 10 sets a “validity period” for the electronic ticket. For example, the server apparatus 10 issues the electronic ticket that is valid only for one minute from the time of issuance. The server apparatus 10 converts the above ticket issued ticket information and the set expiration date into a two-dimensional barcode and generates the electronic ticket.

The server apparatus 10 transmits the generated electronic ticket (the two-dimensional barcode with the expiration date) to the terminal 30.

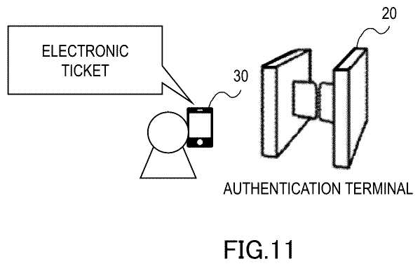

The terminal 30 displays the received electronic ticket (see FIG. 11). The user has the electronic ticket (the two-dimensional barcode displayed on terminal 30) read by a card reader installed in the authentication terminal 20.

The authentication terminal 20 decodes the read two-dimensional barcode and acquires the ticket ID, ticket information, and expiration date. When the expiration date of the electronic ticket has not passed and the ticket information matches the information set in its own apparatus (information to determine that the ticket is valid), the authentication terminal 20 permits the user to pass through a gate.

That is, the authentication terminal 20 permits the user to pass through when the user presents a correct electronic ticket required to enter the restricted admission area managed by the own apparatus, and when the validity period of the presented electronic ticket has not expired.

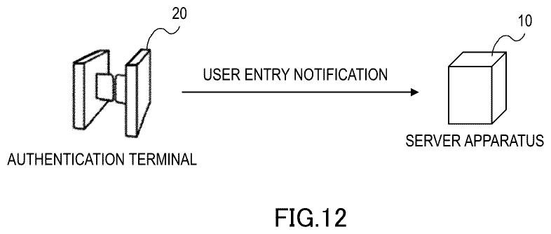

When the authentication terminal 20 permits the user to pass, the authentication terminal 20 transmits a “user entry notification” that includes the ticket ID of the acquired electronic ticket to the server apparatus 10 (see FIG. 12).

The server apparatus 10 searches the sold ticket management database using the ticket ID included in the received user entry notification as a key and deletes the corresponding entry. Alternatively, server apparatus 10 may store in the sold ticket management database that the user of the entry identified by the search has already entered.

Next, details of the individual apparatuses included in the information processing system according to the first example embodiment will be described.

### Server Apparatus

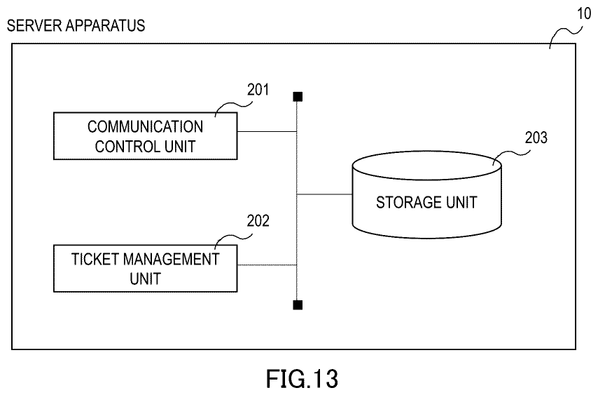

FIG. 13 is a diagram illustrating an example of a processing configuration (processing modules) of the server apparatus 10 according to the first example embodiment. Referring to FIG. 13, the server apparatus 10 includes a communication control unit 201, a ticket management unit 202, and a storage unit 203.

The communication control unit 201 is means for controlling communication with other apparatuses. For example, the communication control unit 201 receives data (packets) from the authentication terminal 20. In addition, the communication control unit 201 transmits data to the authentication terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

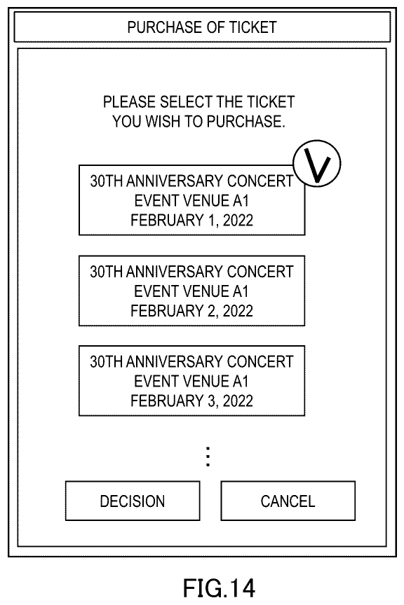

The ticket management unit 202 is means for controlling and managing tickets that users purchase. Specifically, when a user accesses a ticket purchase site by operating the terminal 30, the ticket management unit 202 displays a list of tickets that the user can purchase on the terminal 30 (see FIG. 14).

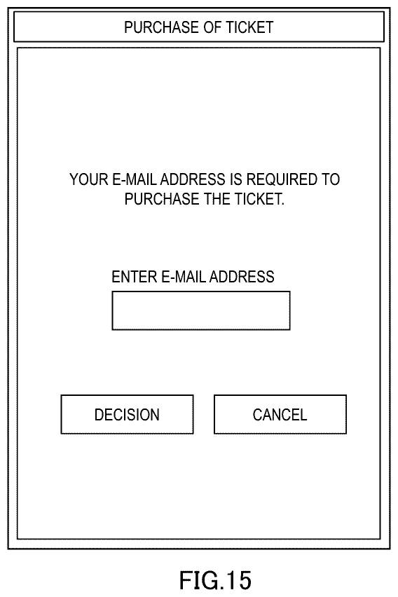

When the user decides which ticket to purchase (when the decision button shown in FIG. 14 is pressed), the ticket management unit 202 displays a GUI for acquiring terminal identifying information (for example, an e-mail address) (see FIG. 15).

When the ticket management unit 202 acquires the terminal identifying information (when the decision button in FIG. 15 is pressed), the ticket management unit 202 generates a ticket ID that identifies the ticket purchased by the user. For example, the ticket management unit 202 assigns a unique ticket ID each time a ticket is sold.

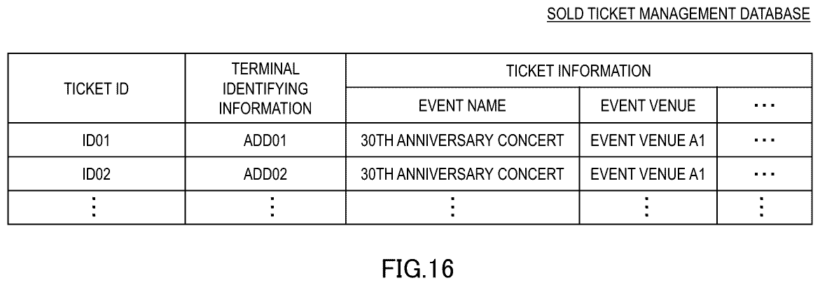

The ticket management unit 202 stores the generated ticket ID, terminal identifying information, and ticket information (information indicating the content of the ticket purchased by the user) in association with each other in the sold ticket management database (see FIG. 16). Note that the sold ticket management database shown in FIG. 16 is an example and is not intended to limit the items to be stored.

The ticket management unit 202 transmits the ticket ID and ticket information of the ticket sold to the user to the terminal 30.

The ticket management unit 202 processes a ticket issuance request received from the terminal 30. The ticket management unit 202 searches the sold ticket management database using the ticket ID included in the ticket issuance request as a key and identifies the corresponding entry.

The ticket management unit 202 compares the terminal identifying information (for example, e-mail address) of the identified entry with the terminal identifying information included in the ticket issuance request.

When the two pieces of terminal identifying information do not match, the ticket management unit 202 determines that the ticket issuance request is from a terminal other than the terminal 30 where the ticket was purchased, and refuses to issue the ticket. In this case, the ticket management unit 202 transmits a negative response indicating that the ticket cannot be issued to the terminal 30.

When the two pieces of terminal identifying information match, the ticket management unit 202 issues the ticket. At first, the ticket management unit 202 determines the expiration date of the ticket to be issued. For example, the ticket management unit 202 sets the expiration date to a date and time that is a predetermined period of time after the ticket management unit 202 receives the ticket issuance request.

The ticket management unit 202 converts the ticket ID, ticket information and expiration date into a two-dimensional barcode such as a QR (Quick Response) code (registered trademark) to generate an electronic ticket. The ticket management unit 202 transmits a positive response indicating that the ticket has been successfully issued to the terminal 30. At that time, the ticket management unit 202 transmits a positive response that includes the above generated electronic ticket (two-dimensional barcode) to the terminal 30.

The ticket management unit 202 receives a “user entry notification” from the authentication terminal 20. The ticket management unit 202 searches the sold ticket management database using the ticket ID included in the received user entry notification as a key, and identifies the corresponding entry. The ticket management unit 202 deletes the identified entry.

Note that a description of payment for the purchased ticket will be omitted. The ticket management unit 202 may acquire account information (bank account or credit card information) from the user and settle a price of the ticket purchase using the acquired account information.

The storage unit 203 is means for storing information necessary for an operation of the server apparatus 10. The ticket management database is established in the storage unit 203.

### Authentication Terminal

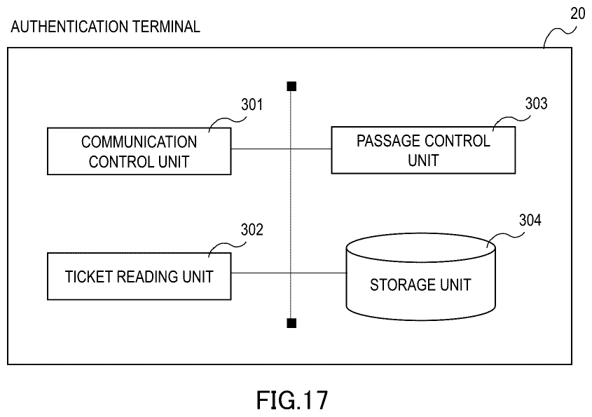

FIG. 17 is a diagram illustrating an example of a processing configuration (processing modules) of the authentication terminal 20 according to the first example embodiment. Referring to FIG. 17, the authentication terminal 20 includes a communication control unit 301, a ticket reading unit 302, a passage control unit 303, and a storage unit 304.

The communication control unit 301 is means for controlling communication with other apparatuses. For example, the communication control unit 301 receives data (packets) from the server apparatus 10. In addition, the communication control unit 301 transmits data to the server apparatus 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The ticket reading unit 302 is means for reading an electronic ticket (two-dimensional barcode) presented by the user. The ticket reading unit 302 controls a barcode reader (not shown) attached to the authentication terminal 20 to read the two-dimensional barcode.

The ticket reading unit 302 decodes the read two-dimensional barcode and acquires the content of the electronic ticket (ticket ID, ticket information and expiration date). The ticket reading unit 302 hands over the acquired content of the electronic ticket to the passage control unit 303.

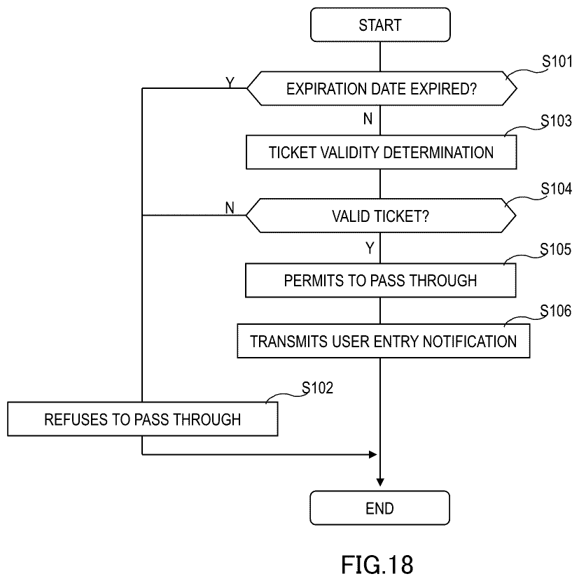

The passage control unit 303 is means for controlling passage of own terminal (admission to a restricted admission area) by the user. FIG. 18 is a flowchart illustrating an example of an operation of the passage control unit 303 according to the first example embodiment. With reference to FIG. 18, the operation of the passage control unit 303 will be describe

The passage control unit 303 determines whether an expiration date of the electronic ticket has passed or not.

When the expiration date has expired (step S101, Yes branch), the passage control unit 303 refuses the user to pass through (step S102). For example, the passage control unit 303 closes a gate attached to the authentication terminal 20.

When the expiration date has not expired (step S101, No branch), the passage control unit 303 determines whether the user possesses a valid ticket that permits the user to enter the restricted admission area (ticket validity determination; step S103).

Specifically, the passage control unit 303 performs the ticket validity determination using ticket information acquired from the electronic ticket and valid ticket determination information that is preset in own terminal.

Note that the valid ticket determination information includes the same type of content as the ticket information. Specifically, the valid ticket determination information includes information to determine the validity of the electronic ticket that the user presents to the authentication terminal 20 such as an event name, event venue, event date and time, and so on.

When the ticket information of the electronic ticket and the valid ticket determination information match, the passage control unit 303 determines that the user possesses a valid ticket (a ticket that permits the user to enter the restricted admission area). When the ticket information of the electronic ticket and the valid ticket determination information do not match, the passage control unit 303 determines that the user does not possess the valid ticket.

When the user does not possess a valid ticket (Step S104, No branch), the passage control unit 303 refuses the user to pass through (Step S102).

When the user possesses a valid ticket (step S104, Yes branch), the passage control unit 303 permits the user to pass through (step S105).

When the passage control unit 303 detects that the user has passed through its own terminal (a gate attached to the authentication terminal 20), the passage control unit 303 transmits a user entry notification that includes the ticket ID of the electronic ticket to the server apparatus 10 (step S106).

Note that the passage control unit 303 detects that the user has passed through the gate using an output signal from a motion sensor or the like.

The storage unit 304 is means for storing information necessary for an operation of the authentication terminal 20.

### Terminal

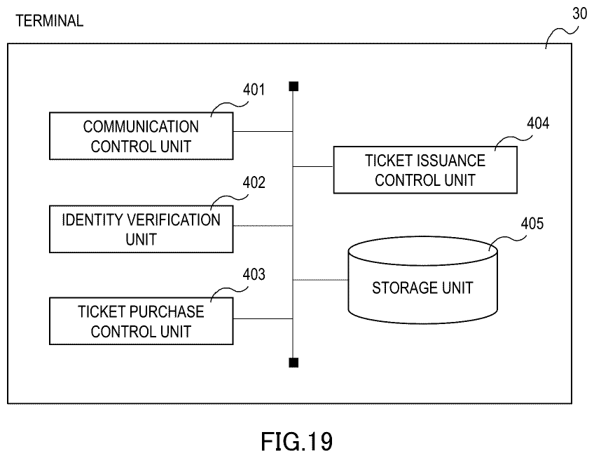

FIG. 19 is a diagram illustrating an example of a processing configuration (processing modules) of the terminal 30 according to the first example embodiment. Referring to FIG. 19, the terminal 30 includes a communication control unit 401, an identity verification unit 402, a ticket purchase control unit 403, a ticket issuance control unit 404, and a storage unit 405.

The communication control unit 401 is means for controlling communication with other apparatuses. For example, the communication control unit 401 receives data (packets) from the server apparatus 10.

In addition, the communication control unit 401 transmits data to the server apparatus 10. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The identity verification unit 402, the ticket purchase control unit 403, and the ticket issuance control unit 404 are realized by the ticket management application installed in the terminal 30. A detailed description of the installation of the ticket management application will be omitted. This is because the installation of the application is obvious to those skilled in the art and is not the purpose of the present application.

The identity verification unit 402 is means for performing identity verification of a ticket purchaser. The identity verification unit 402 performs identity verification of a ticket purchase applicant using biometric authentication of a first biometric information acquired from an identity verification document and a second biometric information of the ticket purchase applicant.

The identity verification unit 402 acquires the identity verification document and biometric information (face image) of a user when the user presses the “Initial Registration” button on a menu screen shown in FIG. 4.

For example, the identity verification unit 402 acquires the identity verification document using a GUI as shown in FIG. 5. The identity verification unit 402 controls a camera device (a camera device that captures an image in front of the terminal 30; not shown) and displays the identity verification document on a preview screen. The identity verification unit 402 captures the image at the timing when the “Shoot” button is pressed, and acquires image data in which the identity verification document is shown.

When the identity verification document has been captured (when the “Next” button in FIG. 5 is pressed), the identity verification unit 402 acquires biometric information of the user. For example, the identity verification unit 402 controls a camera device (a camera device that captures an image of the front of the terminal 30; not shown) and displays the image on the preview screen. The identity verification unit 402 captures an image at the timing when the “Shoot” button is pressed, and acquires biometric information of the user (face image).

The identity verification unit 402 performs biometric authentication (one-to-one authentication) using the face photograph attached to the identity verification document and the face image acquired by capturing an image.

At first, the identity verification unit 402 extracts the face photograph attached to the identity verification document and generates a feature value from the extracted face photograph. Similarly, the identity verification unit 402 generates a feature value from the face image acquired by capturing an image.

Note that since an existing technology can be used to generate the feature values, a detailed description thereof will be omitted. For example, the identity verification unit 402 extracts eyes, nose, mouth, and so on as feature points from the face image. Next, the identity verification unit 402 calculates the location of an individual feature point and the distance between feature points as feature values and generates a feature vector formed by the plurality of feature values (vector information that characterizes the face image).

The identity verification unit 402 calculates the similarity between the two feature values generated above. For the individual similarity, the chi-squared distance, the Euclidean distance, and so on may be used. A longer distance represents a lower similarity, and a shorter distance represents a higher similarity.

When the calculated similarity is greater than or equal to the predetermined value, the identity verification unit 402 determines that identity verification has been successful. When the calculated similarity is smaller than or equal to the predetermined value, the identity verification unit 402 determines that the identity verification has failed.

When the identity verification is successful, the identity verification unit 402 stores the fact in the storage unit 405. Further, the identity verification unit 402 stores the biometric information of the user who has been successfully verified (a face image acquired from an identity verification document, a face image acquired by capturing an image, or a feature value generated from one of the two face images) in the storage unit 405.

When the identity verification fails, the identity verification unit 402 informs the user of the fact. In this case, the identity verification unit 402 may re-acquire the identity verification document or biometric information of the user (face image).

In this way, the identity verification unit 402 performs one-to-one authentication using the first biometric information and the second biometric information to perform identity verification. Furthermore, the identity verification unit 402 stores a third biometric information of a ticket purchase applicant whose identity verification has been successful. Note that the third biometric information may be either the biometric information of the identity verification document (the first biometric information) or the biometric information acquired by photographing (the second biometric information).

The ticket purchase control unit 403 is means for controlling a purchase of a ticket by a user. After identity verification has been successful, the ticket purchase control unit 403 accesses the server apparatus 10 that sells tickets, and receives the ticket ID of the ticket purchased from the server apparatus 10. The ticket purchase control unit 403 stores the received ticket ID in the storage unit 405.

When the identity verification is completed and the “Purchase Ticket” button shown in FIG. 4 is pressed, the ticket purchase control unit 403 accesses a ticket purchase page provided by the server apparatus 10.

The ticket purchase control unit 403 determines the ticket to be purchased on the ticket purchase page provided by the server apparatus 10 in response to an operation by the user (see FIG. 14). Furthermore, the ticket purchase control unit 403 inputs terminal identifying information (for example, an e-mail address) to the server apparatus 10 in response to the operation by the user (see FIG. 15).

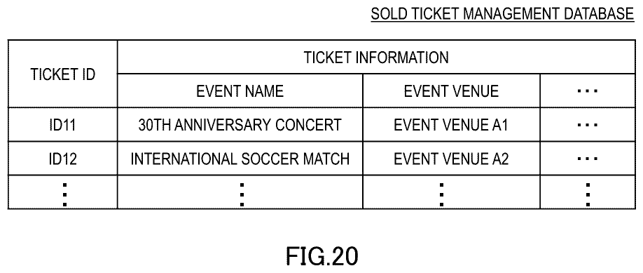

The ticket purchase control unit 403 acquires a ticket ID and ticket information of the purchased ticket from the server apparatus 10. The ticket purchase control unit 403 stores the acquired ticket ID and ticket information in a purchased ticket management database (see FIG. 20). Note that the purchased ticket management database shown in FIG. 20 is an example and is not intended to limit the items to be stored.

The ticket issuance control unit 404 is means for controlling issuance of a purchased ticket. The ticket issuance control unit 404 performs a second biometric authentication using a fourth biometric information of a ticket issuance applicant and the third biometric information acquired in advance (biometric information of the ticket purchaser whose identity verification is determined to be successful). The ticket issuance control unit 404 performs a processing related to issue the ticket when the second biometric authentication has been successful.

When a user presses the “Ticket Issuance” button on a menu screen shown in FIG. 4, the ticket issuance control unit 404 acquires biometric information of the user (the user who intends to issue a ticket).

Specifically, the ticket issuance control unit 404 acquires the biometric information of the user (face image) using a GUI as shown in FIG. 8. When the ticket issuance control unit 404 acquires the face image, the ticket issuance control unit 404 performs a biometric authentication (one-to-one authentication) using the biometric information stored at the time of the identity verification and biometric information acquired through the capture of the face image.

When the biometric authentication is successful, the ticket issuance control unit 404 displays a GUI that allows the user to select a ticket to be issued from among the purchased tickets.

For example, the ticket issuance control unit 404 displays a GUI as shown in FIG. 9. Note that the ticket issuance control unit 404 accesses the purchased ticket management database and displays the GUI as shown in FIG. 9 using ticket information related to tickets that have already been purchased.

When the user selects a ticket to be issued, the ticket issuance control unit 404 transmits a ticket issuance request to the server apparatus 10 that includes a ticket ID of the selected ticket and terminal identifying information (for example, an e-mail address).

The ticket issuance control unit 404 receives a response (positive response or negative response) to the ticket issuance request.

When the ticket issuance control unit 404 receives a negative response (ticket issuance not possible), the ticket issuance control unit 404 notifies the user to that effect.

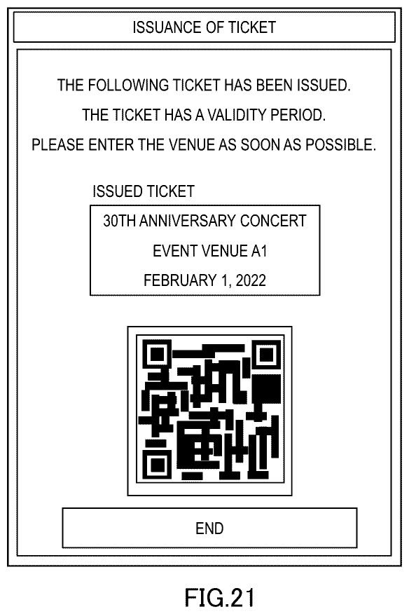

When the ticket issuance control unit 404 receives a positive response (electronic ticket), the ticket issuance control unit 404 displays the acquired electronic ticket (two-dimensional barcode). For example, the ticket issuance control unit 404 displays a screen as shown in FIG. 21.

As shown in FIG. 21, the ticket issuance control unit 404 displays the electronic ticket (two-dimensional barcode) while notifying the user that the electronic ticket has a set validity period.

In this way, the ticket issuance control unit 404 performs a one-to-one authentication using the third biometric information and the fourth biometric information. When the authentication is successful (when the ticket purchaser and the ticket issuance applicant are the same person), the ticket issuance control unit 404 performs a control related to issuance of the ticket. Specifically, the ticket issuance control unit 404 transmits a ticket issuance request including the ticket ID of the ticket that the ticket issuance applicant has requested to be issued to the server apparatus 10. The ticket issuance control unit 404 acquires an electronic ticket from the server apparatus 10 in response to transmitting the ticket issuance request to the server apparatus 10. The ticket issuance control unit 404 acquires the electronic ticket converted into the two-dimensional barcode format and displays the acquired electronic ticket.

The storage unit 405 is means for storing information necessary for the operation of the terminal 30.

### System Operation

Next, operations of the information processing system according to the first example embodiment will be described.

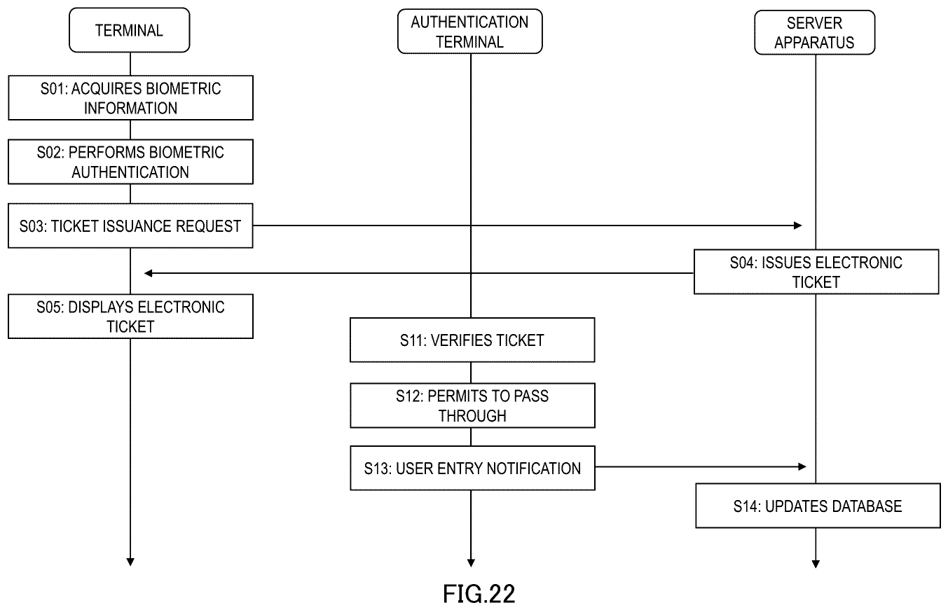

FIG. 22 is a sequence diagram illustrating an example of an operation in the information processing system according to the first example embodiment. Referring to FIG. 22, the operation when a user attempts to enter the restricted admission area will be described. Note that a description of an operation related to identity verification (registration of face image) by the terminal 30 and a description of an operation related to purchase of a ticket will be omitted.

When a user wishes to issue a ticket, the terminal 30 acquires biometric information (face image) of a user (step S01).

The terminal 30 performs biometric authentication using the acquired biometric information and the biometric information acquired at the time of identity verification (step S02).

When the biometric authentication (one-to-one authentication) is successful, the terminal 30 transmits a ticket issuance request that includes the ticket ID of the ticket to be issued to the server apparatus 10 (step S03).

The server apparatus 10 identifies the ticket to be issued based on the ticket ID included in the ticket issuance request, sets the validity period on the identified ticket, and issues an electronic ticket (step S04). In this way, the server apparatus 10 transmits the issued electronic ticket (two-dimensional barcode that includes ticket ID, ticket information, and so on) to the terminal 30.

The terminal 30 displays the issued electronic ticket (two-dimensional barcode that includes the ticket ID, ticket information, and expiration date as information) (step S05).

The authentication terminal 20 reads the electronic ticket (two-dimensional barcode) displayed on the terminal 30.

The authentication terminal 20 verifies the read electronic ticket (step S11). Specifically, the authentication terminal 20 verifies the validity and validity period of the electronic ticket.

If a valid ticket is presented and the expiration date has not passed, the authentication terminal 20 permits the user to pass through (step S12).

When the user passes through the gate (the authentication terminal 20), the authentication terminal 20 transmits a user entry notification that includes the ticket ID to the server apparatus 10 (step S13).

The server apparatus 10 updates the sold ticket management database based on the ticket ID included in the user entry notification (update database; step S14).

As described above, the terminal 30 according to the first example embodiment includes an identity verification function that checks for a match between an identity verification document with a face photograph and a face image captured by a camera device, and a face authentication function that checks for a match between a face image registered in advance and a face image captured by a camera device. The terminal 30 guarantees an identity of a ticket purchaser by allowing only a user who has registered biometric information (face image) using the ticket management application to purchase a ticket. In addition, the terminal 30 prevents resale, or the like, of the purchased ticket by checking the identity of the ticket purchaser and a ticket purchase applicant at the time of issuing the ticket. Furthermore, the server apparatus 10 prevents the resale of tickets more firmly by issuing an electronic ticket that includes an anti-duplication function, such as an electronic ticket for which a validity period has been set. In particular, tickets for which rewards to be provided (premium tickets) are in high demand and require measures to prevent resale, but by using the terminal 30 of the present application, effective measures to prevent resale can be implemented while reducing the burden on event organizers. That is, in the information processing system of the present application, the server apparatus 10 issues a different electronic ticket (two-dimensional barcode) at regular intervals by issuing an electronic ticket for which a very short validity period is set. Since the content of the electronic ticket (pattern of the two-dimensional barcode) changes in a short period of time, it is difficult for others other than the ticket purchaser to make unauthorized use of the two-dimensional barcode displayed on the terminal 30.

In this way, the terminal 30 according to the first example embodiment can provide “smartphone-based face recognition” through its identity verification function and face recognition function. Since biometric authentication can be completed using the terminal 30 possessed by each user, the event organizer and the like do not need to prepare a dedicated terminal, and so on, and investment costs can be reduced. In other words, the event organizer does not need to transport or set up equipment for biometric authentication, which reduces the burden on the day of the event. Moreover, since there is no need to prepare the dedicated terminal, and so on, confusion due to equipment malfunction and the like does not occur. Furthermore, the biometric information required for biometric authentication is stored in the terminal 30 possessed by each user, so there is no need for the event organizer to manage the biometric information, and there are fewer security concerns. Furthermore, the biometric authentication of the information processing system of the present application does not adopt the so-called client-server model, which means that there is no server responsible for biometric authentication, and the system can operate stably even if authentication processing is concentrated in a short period of time.

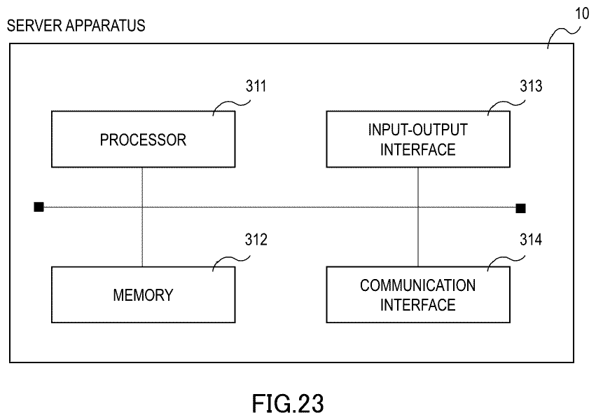

Next, a hardware configuration of an individual apparatus that constitutes the information processing system will be described. FIG. 23 is a diagram illustrating an example of a hardware configuration of the server apparatus 10.

The server apparatus 10 can be configured by an information processing apparatus (a so-called computer) and has a configuration illustrated as an example in FIG. 23. For example, the server apparatus 10 includes a processor 311, a memory 312, an input-output interface 313, a communication interface 314, and so on. The components such as the processor 311 are connected to an internal bus, and so on so that these components can communicate with each other.

The hardware configuration of the server apparatus 10 is not limited to the configuration illustrated in FIG. 23. The server apparatus 10 may include hardware not illustrated or may be configured without the input-output interface 313 if desired. In addition, the number of components, such as the number of processors 311, included in the server apparatus 10 is not limited to the example illustrated in FIG. 23. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the authentication terminal 20 and the terminal 30 can each be configured by an information processing apparatus, and the basic hardware configuration of the authentication terminal 20 and the terminal 30 are the same as that of the server apparatus 10. Thus, description of the basic hardware configuration of the authentication terminal 20 and the terminal 30 will be omitted. For example, the terminal 30 may include a camera device to capture an image of the user, and the authentication terminal 20 may include a bar code reader and a gate.

The server apparatus 10 which is an information processing device includes a computer and can realize its functions by causing the computer to execute a program. In addition, the server apparatus 10 executes a control method of the server apparatus 10 by using this program.

### Variations

The configurations, operations, and so on of the information processing system according to the above example embodiments are examples and do not limit the present system configuration, and so on.

The server apparatus 10 can sell a ticket by any method. The server apparatus 10 may adopt a method in which a ticket is sold on a first-come, first-served basis during the ticket sales period, or the server apparatus 10 may adopt a method in which a user who can purchase the ticket is determined by lottery, regardless of the order in which the applications are made during the ticket sales period.

The above example embodiment describes that the server apparatus 10 checks the identity of the terminal 30 that purchased a ticket and the terminal 30 that requests to issue the ticket using the terminal identifying information (for example, e-mail address, terminal ID). However, since it can be considered that the identity of the terminal 30 that purchased the ticket and the terminal 30 that requests to issue the ticket are checked by biometric authentication at the time of issuing the ticket, it is not necessary to verify the terminal 30 using the terminal identifying information described above. Alternatively, the verification of the terminal 30 using the above terminal identifying information may be performed from the perspective of building a more robust ticket sales system in preparation for a leakage, and the like, of a ticket ID.

The above example embodiment describes a case in which the electronic ticket with a validity period is issued to a user. However, when it is determined that the validity period does not need to be set based on a policy of the event organizer, and so on, the electronic ticket may be issued without the validity period.

The above example embodiment describes a case in which the terminal 30 notifies the user that a validity period is set for the ticket after the ticket has been issued (see FIG. 21). However, the terminal 30 may also notify the user before the ticket is issued (for example, when the user selects the ticket to be issued; see FIG. 9) that the validity period will be set for the ticket to be issued.

When the electronic ticket for which a validity period has been set is issued and a user does not enter an event venue during the validity period, the above-mentioned issued electronic ticket expires. In this case, the user need only operate the terminal 30 to perform a ticket issuance procedure again. Note that the server apparatus 10 may manage the number of times an electronic ticket can be reissued, and prohibit the issuance of the electronic ticket that exceeds a predetermined number of reissues.

The above example embodiment describes that the authentication terminal 20 notifies the server apparatus 10 of a ticket ID of a user who has passed through the gate. In this case, the authentication terminal 20 may also notify the terminal 30 possessed by the user of the ticket ID. For example, the authentication terminal 20 may notify the terminal 30 of the ticket ID using a short-range wireless communication means such as Bluetooth (registered trademark). The terminal 30 deletes the entry in the purchased ticket management database corresponding to the notified ticket ID. Alternatively, the server apparatus 10 may notify the terminal 30 of the ticket ID notified from the authentication terminal 20. The server apparatus 10 notifies the terminal 30 of the generated ticket ID. The terminal 30 may acquire the ticket ID of the ticket used by either method and reflect the use of the ticket in the purchased ticket management database. Alternatively, the terminal 30 may notify the server apparatus 10 of the ticket ID notified from the authentication terminal 20. That is, the user entry notification that includes the ticket ID may be transmitted from the authentication terminal 20 to the server apparatus 10 via the terminal 30.

The terminal 30 may acquire personal information (for example, name, age, gender, address, and so on) of the user from the identity verification document that is acquired at the time of initial registration (identity verification). The terminal 30 may hide the electronic ticket when the terminal 30 determines that the user is not eligible to enter the event venue based on the acquired personal information. For example, when the server apparatus 10 sells a ticket to a user for an event for an adult event, the server apparatus 10 indicates that fact in the ticket information. The terminal 30 does not display the electronic ticket when the ticket information of the issued electronic ticket states the ticket as an “adult ticket”. By this method, the event organizer does not need to verify the age of the user, even if tickets with age restrictions, such as those for public gambling, are sold.

The above example embodiment describes that the electronic ticket is issued at the timing desired by the user, but the electronic ticket may also be issued at the timing when the user purchases the ticket. In this case, the server apparatus 10 transmits a two-dimensional barcode that includes the ticket ID and ticket information to the terminal 30 as the electronic ticket. When the user enters an event venue, the user operates the terminal 30 to display the electronic ticket. At that time, the terminal 30 displays the electronic ticket for a predetermined period of time (for example, one minute) to prevent unauthorized use of the displayed electronic ticket.

Alternatively, in case of lottery-based ticket purchase, the server apparatus 10 transmits an electronic ticket (two-dimensional barcode) to the terminal 30 of the ticket purchaser who has won the lottery, and the terminal 30 stores the electronic ticket internally. When the ticket purchaser enters the event venue, the terminal 30 acquires a face image of the user. The terminal 30 may display the electronic ticket (two-dimensional barcode) acquired from the server apparatus 10 only when biometric authentication is successful using the acquired face image and a face image that has been registered in advance. In this way, the terminal 30 does not need to communicate with the server apparatus 10 when the user enters the event venue.

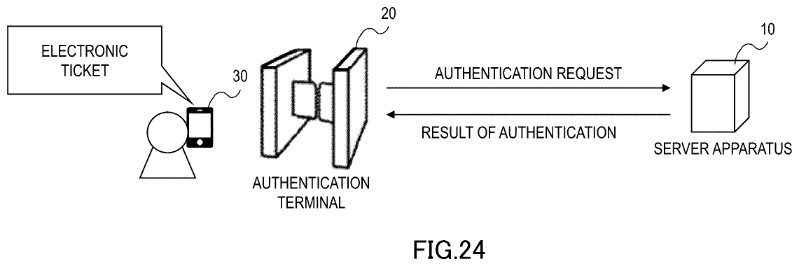

The above example embodiment describes that the authentication terminal 20 determines the validity and validity period of the electronic ticket presented by the user. However, the determination may be made by the server apparatus 10. In this case, the authentication terminal 20 transmits an authentication request that includes the ticket ID and validity period of the electronic ticket read from the terminal 30 of the user to the server apparatus 10 (see FIG. 24). The server apparatus 10 identifies the ticket from the ticket ID included in the authentication request and determines whether or not the user can pass through the authentication terminal 20 with the identified ticket. Further, the server apparatus 10 determines the validity period of the electronic ticket. When the electronic ticket presented by the user is valid for the authentication terminal 20 and the expiration date of the electronic ticket has not passed, the server apparatus 10 transmits an authentication success to the authentication terminal 20.

The above example embodiment describes a case in which the authentication terminal 20 controls the passage of a user. However, the control of the passage of the user may be performed by a staff member or the like dispatched to the event venue. Specifically, a portable terminal possessed by the staff member reads the electronic ticket displayed on the terminal 30 using a bar code reader, the mobile terminal determines the validity and validity period of the electronic ticket, and notifies the staff member of the result of determination. When the staff member is notified that the user is permitted to enter the event venue, the staff member permits the user to enter. When the staff member is notified that the user cannot enter the event venue, the staff member refuses the user entry to the event venue.

The above example embodiment describes that in order to allow only a user whose identity verification has been completed and biometric information (face image) has been registered at the terminal 30 to purchase a ticket, the terminal 30 cannot access the server apparatus 10 unless the identity verification and the registration of the face image have been completed. Here, the server apparatus 10 may permit only the terminal 30 that notifies “identity verification and biometric information has already been acquired” to purchase the ticket. That is, when the user purchases a ticket for biometric authentication, the server apparatus 10 may acquire information of “identity verification and face registration completed” from the terminal 30 (the ticket management application) and sell the ticket only to the user of the terminal 30 that transmits the information.

The above example embodiment describes a case in which the sold ticket management database is configured inside the server apparatus 10, but the database may be established in an external database server or the like. That is, some of the functions of the server apparatus 10 may be implemented in another server. More specifically, the “ticket management unit (ticket management means)”, and so on described above may be implemented in any device included in that includes the system.

While the data exchange between each apparatus (the server apparatus 10, the authentication terminal 20, and the terminal 30) is not limited to any particular mode, data exchanged between these apparatuses may be encrypted. It is desirable that the ticket information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems and the like that sell tickets to users.

A part or the entirety of the example embodiments described above may be described as in the following supplementary notes, but is not limited to the followings.

### Supplementary Note 1

A terminal including:
an identity verification unit that performs an identity verification of a ticket purchase applicant by a first biometric authentication using a first biometric information acquired from an identity verification document and a second biometric information of the ticket purchase applicant, and stores a third biometric information of the ticket purchase applicant who has been successfully verified; and
a ticket issuance control unit that performs a second biometric authentication using a fourth biometric information of a ticket issuance applicant and the stored third biometric information, and performs a processing related to an issuance of a ticket when the second biometric authentication has been successful.

### Supplementary Note 2

The terminal according to supplementary note 1, further including a ticket purchase control unit that accesses a server apparatus that sells tickets after the identity verification has been successful, receives a ticket ID of a ticket purchased from the server apparatus, and stores the received ticket ID.

### Supplementary Note 3

The terminal according to supplementary note 2, wherein the ticket issuance control unit transmits a ticket issuance request including the ticket ID of the ticket that the ticket issuance applicant has requested to be issued to the server apparatus.

### Supplementary Note 4

The terminal according to any one of supplementary notes 1 to 3, wherein identity verification unit performs one-to-one authentication using the first biometric information and the second biometric information to perform the identity verification.

### Supplementary Note 5

The terminal according to supplementary note 4, wherein the ticket issuance control unit performs one-to-one authentication using the third biometric information and the fourth biometric information, and performs a control related to the issuance of the ticket when the ticket purchaser and the ticket issuance applicant are the same person.

### Supplementary Note 6

The terminal according to supplementary note 3, wherein the ticket issuance control unit acquires an electronic ticket from the server apparatus in response to transmitting the ticket issuance request to the server apparatus.

### Supplementary Note 7

The terminal according to supplementary note 6, wherein the ticket issuance control unit acquires the electronic ticket converted into a two-dimensional barcode format and displays the acquired electronic ticket.

### Supplementary Note 8

The terminal according to supplementary note 7, wherein the electronic ticket has a validity period.

### Supplementary Note 9

The terminal according to any one of supplementary notes 1 to 8, wherein the first to fourth biometric information are face images or feature values generated from the face images.

### Supplementary Note 10

A system including:
a server apparatus that sells tickets; and
a terminal,
wherein the terminal includes:
an identity verification unit that performs an identity verification of a ticket purchase applicant by a first biometric authentication using a first biometric information acquired from an identity verification document and a second biometric information of the ticket purchase applicant, and stores a third biometric information of the ticket purchase applicant who has been successfully verified;
a ticket purchase control unit that accesses the server apparatus after the identity verification has been successful, receives a ticket ID of a ticket purchased from the server apparatus, and stores the received ticket ID; and
a ticket issuance control unit that performs a second biometric authentication using a fourth biometric information of a ticket issuance applicant and the stored third biometric information, and performs a processing related to an issuance of a ticket when the second biometric authentication has been successful.

### Supplementary Note 11

A control method of a terminal, the control method including:
performing an identity verification of a ticket purchase applicant by a first biometric authentication using a first biometric information acquired from an identity verification document and a second biometric information of the ticket purchase applicant, and storing a third biometric information of the ticket purchase applicant who has been successfully verified; and
performing a second biometric authentication using a fourth biometric information of a ticket issuance applicant and the stored third biometric information, and performing a processing related to an issuance of a ticket when the second biometric authentication has been successful.

### Supplementary Note 12

A computer-readable storage medium storing a program causing a computer mounted on a terminal to perform processing for:
performing an identity verification of a ticket purchase applicant by a first biometric authentication using a first biometric information acquired from an identity verification document and a second biometric information of the ticket purchase applicant, and storing a third biometric information of the ticket purchase applicant who has been successfully verified; and
performing a second biometric authentication using a fourth biometric information of a ticket issuance applicant and the stored third biometric information, and performing a processing related to an issuance of a ticket when the second biometric authentication has been successful.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10 server apparatus
20 authentication terminal
30 terminal
100 terminal
101 identity verification unit
102 ticket issuance control unit
201 communication control unit
202 ticket management unit
203 storage unit
301 communication control unit
302 ticket reading unit
303 passage control unit
304 storage unit
311 processor
312 memory
313 input-output interface
314 communication interface
401 communication control unit
402 identity verification unit
403 ticket purchase control unit
404 ticket issuance control unit
405 storage unit

What is claimed is:

1. A terminal comprising:
at least one memory storing a set of instructions; and
at least one processor configured to execute the set of instructions to:
perform an identity verification of a ticket purchase applicant by a first biometric authentication using a first biometric information acquired from an identity verification document and a second biometric information of the ticket purchase applicant, and store a third biometric information of the ticket purchase applicant who has been successfully verified; and
perform a second biometric authentication using a fourth biometric information of a ticket issuance applicant and the stored third biometric information, and perform a processing related to an issuance of a ticket when the second biometric authentication has been successful.

2. The terminal according to claim 1, wherein
the at least one processor is further configured to execute the set of instructions to:
hat accesses a server apparatus that sells tickets after the identity verification has been successful, receive a ticket ID of a ticket purchased from the server apparatus, and store the received ticket ID.

3. The terminal according to claim 2, wherein
the at least one processor is further configured to execute the set of instructions to:
transmit a ticket issuance request including the ticket ID of the ticket that the ticket issuance applicant has requested to be issued to the server apparatus.

4. The terminal according to any one of claims 1 to 3, wherein
the at least one processor is further configured to execute the set of instructions to:
perform one-to-one authentication using the first biometric information and the second biometric information to perform the identity verification.

5. The terminal according to claim 4, wherein
the at least one processor is further configured to execute the set of instructions to:
perform one-to-one authentication using the third biometric information and the fourth biometric information, and perform a control related to the issuance of the ticket when the ticket purchaser and the ticket issuance applicant are the same person.

6. The terminal according to claim 3, wherein
the at least one processor is further configured to execute the set of instructions to:
acquire an electronic ticket from the server apparatus in response to transmitting the ticket issuance request to the server apparatus.

7. The terminal according to claim 6, wherein
the at least one processor is further configured to execute the set of instructions to:
acquire the electronic ticket converted into a two-dimensional barcode format and display the acquired electronic ticket.

8. The terminal according to claim 7, wherein the electronic ticket has a validity period.

9. The terminal according to claim 1, wherein the first to fourth biometric information are face images or feature values generated from the face images.

10. A system comprising:
a server apparatus that sells tickets; and
a terminal,
wherein the terminal comprises:
at least one memory storing a set of instructions; and
at least one processor configured to execute the set of instructions to:
perform an identity verification of a ticket purchase applicant by a first biometric authentication using a first biometric information acquired from an identity verification document and a second biometric information of the ticket purchase applicant, and stores a third biometric information of the ticket purchase applicant who has been successfully verified;
access the server apparatus after the identity verification has been successful, receive a ticket ID of a ticket purchased from the server apparatus, and store the received ticket ID; and
perform a second biometric authentication using a fourth biometric information of a ticket issuance applicant and the stored third biometric information, and perform a processing related to an issuance of a ticket when the second biometric authentication has been successful.

11. A control method of a terminal, the control method comprising:
performing an identity verification of a ticket purchase applicant by a first biometric authentication using a first biometric information acquired from an identity verification document and a second biometric information of the ticket purchase applicant, and storing a third biometric information of the ticket purchase applicant who has been successfully verified; and
performing a second biometric authentication using a fourth biometric information of a ticket issuance applicant and the stored third biometric information, and performing a processing related to an issuance of a ticket when the second biometric authentication has been successful.

12. (canceled)
